(19) United States
(12) Patent Application Publication
(10) Pub. No.: US 2006/0046845 A1
(43) Pub. Date: Mar. 2, 2006

(54) Device for the acoustic control of a game system and application

(76) Inventors: Alexandre Armand, Gaillard (FR); Bram Dauw, Vinzel (CH)

Correspondence Address: Clifford W. Browning, Suite 3700, 111 Monument Circle, Indianapolis, IN, 46204-5137, US

(21) Appl. No.: 10/999,774

(22) Filed: Nov. 30, 2004

(30) Foreign Application Priority Data
Aug. 26, 2004 (CH) 01404/04

(51) Int. Cl. G06F 17/00; G06F 19/00

(52) U.S. Cl. 463/35

(57) ABSTRACT

An acoustic control device for a game system, comprising a microphone and a processor delivering a signal controlling a function of the game, this signal depending on the intensity of the sounds picked up by the microphone. The control device can be integrated in a helmet and can comprise a vibrating device triggered by virtue of a feedback connection in certain specific situations of the game.

### FIELD OF THE INVENTION

The present invention concerns a device for the acoustic control of a game system. The invention also concerns an application of this acoustic control device.

### BACKGROUND OF THE INVENTION

Electromechanical games involving miniature car races comprise a support simulating the route of a reduced-scale racing circuit all along which two electrically conductive tracks extend in which the contact elements of the electric motors of two miniature cars are inserted. The movement of the cars is controlled by a pair of touch-control devices, generally in the form of joysticks with a button, the pressing or release of which generates an electrical signal, converted in an analogue fashion into a supply voltage for the motive parts of the miniature cars, approximately proportional to the magnitude of the movement of the fingers of the players.

In the majority of video game systems simulating races or combats, the visual sequences are controlled by means of buttons or joysticks, or mice whose movements in various directions are translated in the form of digital signals controlling the series of visual sequences generated by the game software.

The physical activity of the players is therefore limited essentially to movements of the fingers accomplished with varying degrees of dexterity. The result of the game is generally limited to visually noting what occurs on the monitor screen or what happens to the miniature cars placed and moving on the circuit.

The physical sensations of the players are objectively weak and, in order to experience subjectively strong sensations, the players are obliged to cut themselves off mentally from the real world and concentrate on the visual perception of the game. Likewise, the gratification in the event of success or sanction in the event of failure are limited essentially to a visual perception, although in many video games the visual sequences are emphasised by corresponding sound effects.

It has already been proposed to replace or supplement the aforementioned control devices with voice control means, the player using his voice to enter specific instructions into the game system. By way of example, the document GB 2 292 443 describes a device of the type defined at the start in which the signal processor comprises a voice recognition device capable of recognising a certain number of words/instructions such as “go”, “stop”, “turn”, “jump”, “fire”, “lie down”, etc.

Such devices give substance to the palette of instructions able to be entered rapidly into the game system. However, despite their simple and brief character, such instructions remain cognitive and controlled, and do not involve any increased physical and instinctive participation on the part of the players.

One aim of the present invention is to propose means of controlling a game whose use is more instinctive than the use of mice or keypads, or even joysticks.

A second aim of the invention is to propose control means using the primary means of expression of the individual in order to facilitate a regressive behaviour which many games attempt to offer, whilst achieving this only very partially, because of an excessively great involvement of the reasoned intellectual faculties.

Another aim of the invention is to offer the player direct sensory stimuli, according to the result of the game, rather than intellectually noting success or failure.

Another aim is to offer a device whose cost is sufficiently low to be able to acquired as a game accessory by the greatest possible number.

### SUMMARY OF THE INVENTION

These aims are achieved by virtue of an acoustic control device for a game system, comprising a microphone delivering a first electrical signal, a signal processor processing the said first signal and delivering a second electrical signal, an output port compatible with an input port of the game system, the said second electrical signal being capable of controlling a function of the game, wherein the said second electrical signal is a function of the intensity of the sound generating the first electrical signal.

Preferred embodiments of the device are:

a control device wherein the second electrical signal is also a function of the frequency spectrum of the said sound,

a control device wherein the game device is an electromechanical game and in that the second electrical signal controls a current supply determining a movement of pieces of the game,

a control device wherein the game device is a video game and in that the second electrical signal controls the running of a visual sequence of the game,

a control device comprising means for discriminating the sounds produced by a player to whom other sounds picked up by the microphone are attributed.

a control device comprising an input port for a return signal, generated by the occurrence of one or more events chosen from amongst the events liable to occur in the execution of the game, and first means generating a sensory stimulus for the player to which the said device is allocated, triggered by the said return signal,

a control device wherein the said generating means comprise a first vibrating device,

a control device comprising a helmet to which the said microphone and the said first vibrating device are fixed, and

a control device comprising a second device generating a sensory stimulus, arranged so as to act on a part of the body of the player other than the part on which the said first stimulus-generating means act.

These aims are also achieved by virtue of a vehicle race game system comprising at least one pair of control devices as mentioned above, the speed of each of the said vehicles being an increase in function of the intensity of the sounds emitted by the player to which the said vehicle is allocated.

In a preferred system, the first vibrating device of each control device comes into action when one of the following events affecting the corresponding vehicle occurs: leaving the road, accident or breakdown.

In a further preferred system, the said second stimulus-generating means come into action when the said first electrical signal exceeds a predetermined threshold and none of the said predetermined events has occurred during a predetermined period.

According to the invention, it is the intensity of the sounds produced by the player which determines the second electrical signal and, therefore, a function of the game, preferably an essential function, such as the speed of the vehicles in a vehicle race game.

The sounds can be produced via a percussion or string instrument, or any other noisy means. The sound can be produced simply by the voice of the player wearing the microphone on him. The player can in particular

utter inarticulate yells enabling him to let off steam, which would not be well tolerated on the part of an adult in other circumstances,

proffer onomatopoeias such as “vroom vroom”, where it is a case of motor races, thus regressing to infantile behaviour,

utter lumberjack “grunts”, where it is a case of a tennis video game, in order to imitate certain male or female champions, etc.

Replacing the analysis of the cognitive content of vocal instructions by a simple measure of the acoustic intensity of this message has the double advantage

of enabling/obliging the player or players to devote themselves to a relatively intense physical activity, about which it is known, in particular through primal scream based therapies, that it can afford not insignificant psychophysiological satisfaction to the players,

of enabling practically all individuals to play video games, whatever their intellectual level and/or state.

According to a variant of the device according to the invention, the second electrical signal can also be a function of the frequency spectrum of the sounds received by the microphone, a growl in the deep register being able to be associated with a different function from that associated with a high-pitched cry. By way of example, two different cries can be associated respectively with “accelerate” and “brake”, the intensity of the acceleration or braking always being a function of the intensity of the sounds proffered by the player.

To avoid the command sounds produced by the player being interfered with by the cries of the other player or players, means can be provided for discriminating the sounds produced by the player to whom the microphone of the control device is allocated from the surrounding sounds. It is possible, for example, to provide for the use of highly directional microphones.

The acoustic control device according to the invention can be the only device controlling the game. It can also cooperate with a control device of the prior art such as a joystick or steering wheel. It is possible for example to provide an acoustic control device according to the invention for controlling the acceleration and/or braking of vehicles, the human voice and this device then replacing the action of the feet and corresponding pedals of a car. To control steering to the left or right in the context of a video game, the device can be supplemented by a joystick or steering wheel, known from the prior art.

A preferred embodiment of the invention comprises a sensory feedback system. The occurrence of certain preselected events liable to arise in the execution of the game, such as leaving a path, exceeding a limit speed, etc, generates, in an electromechanical game device, variations in electrical voltage or current or, in the case of a video game, digital signals, which may be sensed, transformed and returned to the control device. The detection of such signals triggers the activation of a device generating a sensory stimulus for the player. Such a sensory stimulus can be a light signal, such as a flash, or a specific noise. The invention preferably uses a vibrating device acting mechanically on a part of the body of the player, such a device operating an immediate physical sanction in the case of failure during the game, rather than a simple record of this failure.

According to a preferred embodiment of the invention, the control device comprises a helmet to which the microphone is fixed. In this case, the vibrating device is also preferably fixed to the helmet so as to transmit its vibration to the head of the player when one of the aforementioned events occurs.

The use of a vibrating helmet makes it possible to complicate the game by making it more difficult, the vibrations acting on the head of a player interfering with his visual perception capabilities and his ability to concentrate.

According to particular embodiments, the vibrating device can emit two distinct types of vibration or the control device can comprise a second device generating sensory stimuli, in particular a second vibrating device. A second vibrating device of this type is preferably arranged so as to act on a part of the body of the player other than the head, in order better to differentiate its effect from the effect of the first vibrating device. By way of example, the first vibrating device can generate an uncomfortable vibration on the skull of the player, sanctioning an accident or any other form of failure in the context of the game, whilst the second vibrating device can consist of a vibrating cushion placed behind the back or under the buttocks of a player, in order to stimulate or recompense for the achievement of certain performances. By way of example, a vibrating cushion can come into action when the speed of the “driven” vehicle exceeds a certain threshold.

### BRIEF DESCRIPTION OF THE DRAWINGS

Other characteristics and advantages of the invention will become clear to a person skilled in the art by virtue of the detailed description of the following embodiment, in relation to the drawing, in which

FIG. 1 shows schematically the arrangement of the components of the device according to the invention,

FIG. 2 shows an operating diagram of the vibrating device,

FIGS. 3 and 4 are photographs showing an embodiment of the device of the invention in the form of a helmet.

### DETAILED DESCRIPTION OF PREFERRED EMBODIMENTS

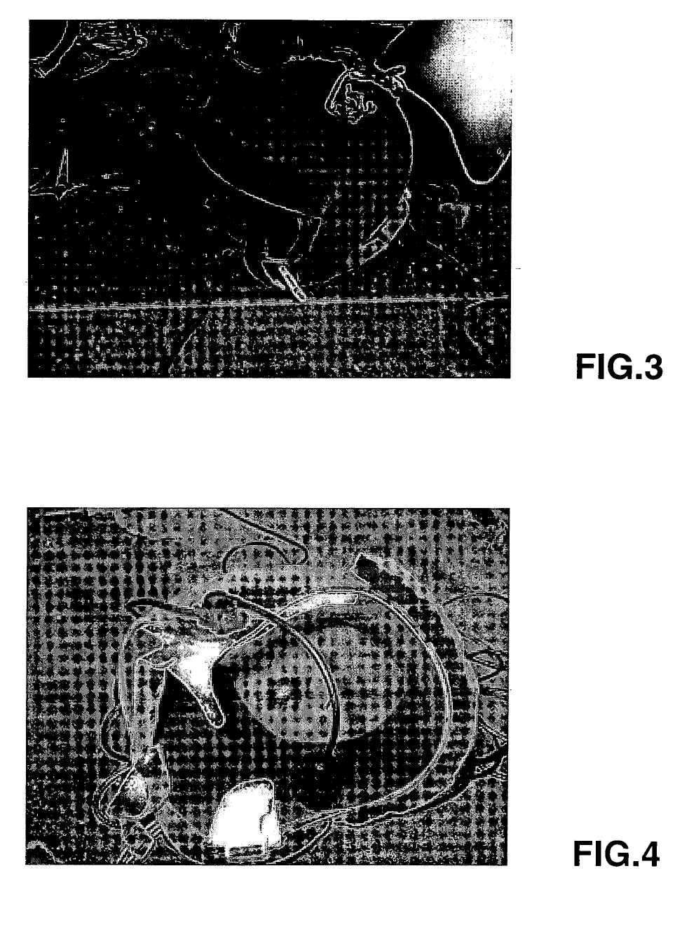

FIGS. 3 and 4 show a helmet which can be chosen from amongst a motorcycle helmet or car competition helmets, commercially available. Part of the padding can be removed locally, for example at the top of the head. On a lower lateral part of the helmet a microphone is fixed in a conventional manner. Such microphones are known in the prior art used in particular in car rallies. At the top of the helmet the vibrating device is fixed. The vibrating device comprises an electrical micromotor supplied by direct current. Such direct-current motors are available commercially. The spindle of the electric motor carries an additional weight so that the whole is unbalanced mechanically, so that rotating the motor makes the helmet vibrate, which transmits this vibration to the head of the player. The assembly can comprise a second external shell for protecting the vibrating device, as well as for aesthetic reasons.

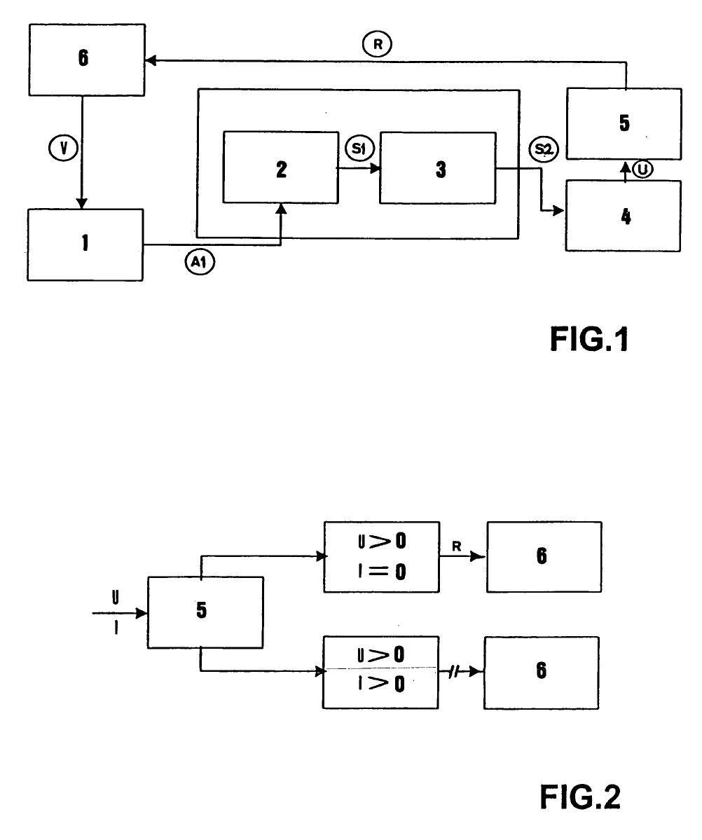

FIG. 1 shows in diagram form the whole of the device allocated to the first player. An identical device is allocated to a second player or other players if necessary. The player 1 generates an acoustic signal A1, which may range from a murmur, or even silence, to yelling; the microphone 2 transforms this acoustic signal into a first electrical signal S1; the signal S1 is converted by the processor 3 into a second signal S2, whose voltage corresponds to the supply voltage of a game track 4 for miniature electromechanical cars. This voltage is proportional to the intensity of the cries or onomatopoeias picked up by the microphone, and the speed of the vehicle is proportional to this voltage.

As shown schematically in FIG. 2, the current I and the voltage U of each track are picked up by a detector 5. If the electrical voltage U and current I are different from 0 and exceed minimum thresholds, this means that the miniature vehicle is travelling on the track, and the detector does not emit any feedback signal R. If the current I falls to 0 the supply voltage U of the track is non-zero, and this means that the miniature vehicle has left its track, the detector picks up this event and sends a signal R to the processor 6 in the helmet, which triggers the DC micromotor, making the helmet vibrate, which transmits a mechanical vibration V to the player 1. If the intensity and voltage measured by the detector are both non-zero, but below predetermined thresholds, this means that the vehicle is travelling very slowly, and the processor can be programmed to react or not to this situation. Finally, if the voltage and current measured exceed a certain value, this means that the speed of the vehicle is exceeding a corresponding speed. This situation is also detected and normally does not generate any reaction at the helmet. In a variant, another control signal can be sent to the vibrating device or to a second vibrating device disposed for example on a seat where the player is seated.

The vibrating helmets described above can find many other applications:

used in combat video games, they can be vibrated if the game system detects the fact that the player has just had an effective blow inflicted on him;

used in an adventure game, they can start to vibrate if the system detects for example a fall;

used in musical games, the vibrating helmet can be vibrated according to the rhythm of the music, thus acting in synergy with it.

A person skilled in the art will easily understand that vibrating helmets can also react to game situations caused by the use of joysticks or other touch controls.

What is claimed is:

1. An acoustic control device for a game system, comprising
a microphone delivering a first electrical signal,
a signal processor processing the said first signal and delivering a second electrical signal,
an output port compatible with an input port of the game system,
the said second electrical signal being capable of controlling a function of the game,
wherein the said second electrical signal is a function of the intensity of the sound generating the first electrical signal.

2. A control device according to claim 1, wherein the second electrical signal is also a function of the frequency spectrum of the said sound.

3. A control device according to claim 1, wherein the game device is an electromechanical game and the second electrical signal controls a current supply determining a movement of pieces of the game.

4. A control device according to claim 1, wherein the game device is a video game and the second electrical signal controls the running of a visual sequence of the game.

5. A control device according to claim 1, comprising means for discriminating the sounds produced by a player to whom other sounds picked up by the microphone are attributed.

6. A control device according to claim 1, comprising an input port for a return signal, generated by the occurrence of one or more events chosen from amongst the events liable to occur in the execution of the game, and first means generating a sensory stimulus for the player to which the said device is allocated, triggered by the said return signal.

7. A control device according to claim 6, wherein the said generating means comprise a first vibrating device.

8. A control device according to claim 6, comprising a helmet to which the said microphone and the said first vibrating device are fixed.

9. A control device according to claim 7, comprising a second device generating a sensory stimulus, arranged so as to act on a part of the body of the player other than the part on which the said first stimulus-generating means act.

10. A control device according to claim 9, wherein said second device is a second vibrating device.

11. A vehicle race game system comprising at least one pair of control devices according to claim 1, the speed of each of the said vehicles being an increase in function of the intensity of the sounds emitted by the player to which the said vehicle is allocated.

12. A vehicle race game system comprising one or more control devices according to claim 7, wherein the first vibrating device of each control device comes into action when one of the following events affecting the corresponding vehicle occurs: leaving the road, accident or breakdown.

13. A vehicle race game system comprising one or more control devices according to claim 9, wherein the first vibrating device of each control device comes into action when one of the following events affecting the corresponding vehicle occurs: leaving the road, accident or breakdown, and wherein the said second stimulus-generating means come into action when the said first electrical signal exceeds a predetermined threshold and none of the said predetermined events has occurred during a predetermined period.
